(19) United States
(12) Patent Application Publication
(10) Pub. No.: US 2003/0204953 A1
(43) Pub. Date: Nov. 6, 2003

(54) Rapid-action reciprocating shaver

(76) Inventor: Murad David, Herzelia (IL)

Correspondence Address: Ladas & Parry, 26 West 61 Street, New York, NY, 10023, US

(21) Appl. No.: 10/140,016

(22) Filed: May 6, 2002

(51) Int. Cl. B26B 19/04

(52) U.S. Cl. 30/43.92; 30/346.51

(57) ABSTRACT

A rapid-action dry shaver having a shaving head adapted to sweep over a broad skin path on the face of the individual being shaved to shear the facial hairs on the path. The head includes a trio of rectangular reciprocating shaver assemblies forming the legs of an equilateral triangle, the face of each assembly making contact with a corresponding area of the facial skin whereby the aggregate skin area engaged by the head is relatively large and facial hairs are intercepted by the head regardless of the direction taken by the sweep to quickly shear substantially all of the hairs in the path.

### BACKGROUND OF THE INVENTION

1. Field of the Invention

This invention relates generally to shavers for removing facial hair, and in particular to a shaver having a head formed by a plurality of reciprocating shaver assemblies in a configuration which promotes a rapid shaving operation.

2. Status of Prior Art

In order to shave facial hair, or hair of other body portions, an individual today uses for this purpose either a wet or dry shaver, his choice depending on which type best satisfies his requirements. The ideal shaver for an individual is one giving the closest shave in the shortest possible time without adverse effects.

A wet shaver employs a safety razor in conjunction with a shaving cream which is applied to a wet face to condition the hairs to be shaved by a blade whose edge makes direct contact with the skin. As it is drawn across the skin, the blade shears all hairs in its path to provide a close shave.

It does not take long for a razor to shave the entire face of an individual, in that unlike a dry shaver, there is no need for a razor to sweep repeatedly back and forth in order to shear all of the hairs. Because these hairs are direct contact with the razor blade at its junction with the skin, few can escape its sharp edge when the blade is drawn across the skin.

Nevertheless shaving with a safety razor is not quit safe, for when its cutting edge is drawn across the skin, it then shears off an epidermal layer in the course of which it may cut or nick the skin, giving rise to a skin infection or other skin disorder. This hazard is avoided by an electrically powered dry shaver regardless of its type.

A reciprocating dry shaver, such as that shown in U.S. Pat. No. 6,082,004 to Hotani, includes an arch-shaped movable cutter that is motor-driven to reciprocate with respect to a fixed cutter. The fixed cutter is apertured or slitted to admit facial hairs which are then sheared by the reciprocating blade. A typical reciprocating dry shaver has a thin metal foil that is apertured to admit facial hairs which then protrude from the apertures. Since this foil is interposed between the skin and the reciprocating blade, the thinner the foil, the closer the shave. It is therefore possible with a dry shaver of the reciprocating type to have a close shave.

When the head of this reciprocating shaver sweeps across the skin it is only the hairs combed into the apertures of the foil that are subjected to a shearing action. In order therefore to shear all of the facial hairs, one must repeatedly sweep back or forth on the skin of the face until it is substantially free of hairs. This need to sweep back and forth with a dry shaver slows down the shaving process so that it takes more time to shave with a dry shaver than with a razor. Differences in shaving time make a difference to typical shaver who usually shaves in the morning before going to work and is therefore tight for time.

In a rotary type dry shaver such as the shaver shown in U.S. Pat. No. 6,032,965 to Hodges, the head is provided with a fixed slotted upper grid and a motor-driven lower grid which rotates to shear off the hairs protruding through the upper grid. In some types of rotary shavers, the rotatable blade is oscillated rather than rotated.

The most popular rotary dry shaver is the type illustrated in U.S. Pat. No. 5,007,168 to Messinger et al. in which the head of the shaver is provided with a trio of cutting assemblies in a triangular configuration, each having an annular fixed cutter which cooperates with a lower cutter which is received within the annulus. The commercially well-known “Phillips” shaver has a multi-assembly head of this type.

While a trio of rotary shavers affords a more rapid shave than a single assembly rotary shaver; the speed of this shaver is limited by the relatively small skin area that is engaged by each annular cutter.

### SUMMARY OF THE INVENTION

In view of the foregoing, the main object of this invention is to provide a shaver whose head has a plurality of reciprocating shaver assembly which acts to expedite the shaving process without adverse side effects. The shaver may be a so-called wet or a dry shaver, or a so-called combined wet and dry shaver.

A significant feature of a shaver in accordance with the invention is that its reciprocating shaver assemblies are each provided with an apertured metal foil which makes contact with a broad skin area to effect a close shave.

More particularly an object of this invention is to provide a shaver of the above type in which the head of the shaver includes a plurality of linear-reciprocating shaver assemblies in a configuration whose aggregate area of contact with the skin is large and therefore shears a considerable amount of hairs as the head sweeps over the skin. According to one particular embodiment, there is a trio of shaver assemblies arranged in a triangular configuration.

Also an object of the invention is to provide a multi-assembly reciprocating shaver that is efficient and reliable in operation and can be mass-produced at relatively low cost in that it includes a trio of identical reciprocating shaver assembly modules.

Briefly stated, these objects are attained in a rapid-action shaver having a shaving head adapted to sweep over a broad skin path on the face of an individual being shaved to shear the facial hairs in this path. The head includes at least three rectangular linear reciprocating shaver assembly modules forming the legs of a closed shape, the face of each assembly making contact with a corresponding area of the facial skin whereby the aggregate skin area engaged by the head is relatively large and facial hairs are intercepted by the head regardless of the direction taken by the sweep to shear substantially all of the hairs in this path. According to a particular embodiment, there are provided three shaving modules forming an equilateral triangle.

### BRIEF DESCRIPTION OF THE DRAWINGS

For a better understanding of the invention as well as other objects and features thereof, reference is made to the annexed drawings wherein;

FIG. 1 shows the head of a prior art rotary dry shaver having a trio of annular rotary cutter assemblies;

FIG. 2 illustrates the geometry of the prior art trio of rotary cutters;

FIG. 3 illustrates the trio of reciprocating assemblies in the head of a shaver in accordance with the invention;

FIG. 4 is an exploded view, partially schematic of a shaver in accordance with the invention; and

FIG. 5 shows one of the reciprocating cutter assemblies included in the shaver according to the present invention.

### DETAILED DESCRIPTION OF THE INVENTION

A shaver in accordance with the invention includes a head that houses, as shown schematically in FIG. 3, three regular reciprocating cutter assemblies X, Y and Z arranged to define the legs of an equilateral triangle T.

The rectangular face of each assembly or module is formed by an apertured metal foil which when the assembly shaver makes direct contact with a corresponding skin area, the hairs encompassed by this skin area are admitted into the apertures as the foil combs skin surface during the sweep of the lead thereacross.

The head carrying the triangular trio of rectangular reciprocating shaver assemblies X, Y and Z sweeps along a skin path which is relatively broad, for its width is determined by the lateral dimension of the triangle. The hair encountered by the head are sheared regardless of the direction taken by the path, for whatever its direction all of the assemblies will lie within the boundaries of the path and will intercept the hairs combed by the apertured foils thereof.

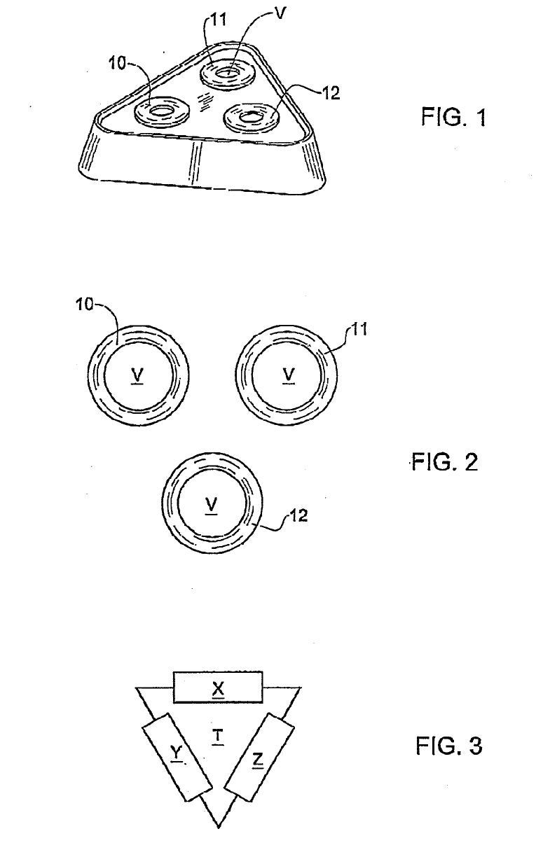

FIGS. 1 and 2 illustrate a prior art rotary shaver head having a trio of rotary shaver assemblies 10, 11 and 12 in a triangular configuration. Each assembly includes a fixed annular upper blade that is slitted to admit facial hairs to be sheared by a rotating lower blade. FIG. 2 illustrates the geometry of is prior art arrangement whose annular assemblies 10, 11 and 12 are each represented by a ring having a large inner diameter to define a void V. Because these voids arm relatively large and there are unused areas between the three rings, the aggregate operative areas of the head which engage corresponding skin areas of the shaver are not large.

It is therefore necessary, in order to complete a shaving operation, to repeatedly sweep the head of the prior art rotary shaver back and forth until all hairs of the face have been sheared. This shaving operation therefore cannot be consummated in a short period. Nor is it possible with a rotary shaver to obtain as close a shave as with a reciprocating dry shaver in which it is only a very thin metal that interposed between the shaver and the skin.

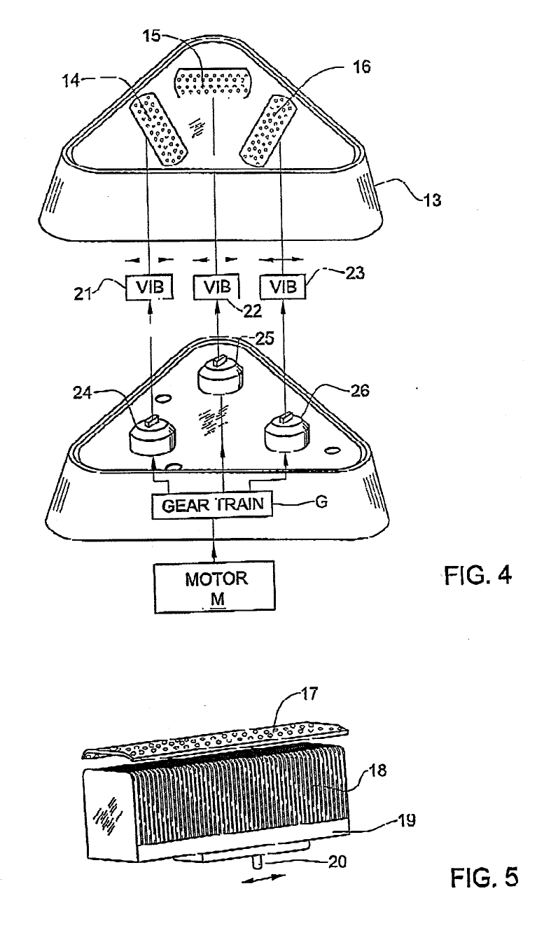

FIG. 4 illustrates a reciprocating dry shaver in accordance with the invention whose head 13 has the geometry shown in FIG. 1 and possesses the advantages afforded by this geometry. Head 13 houses a trio of rectangular reciprocating shaver assemblies 14, 15 and 16. Each assembly or module as shown separately in FIG. 5, includes a rectangular apertured stainless steel foil 17 which forms the outer face of the assembly in contact with the skin, the assembly functioning to comb the hairs it encounters to cause the hair to enter the apertures and protrude therefrom.

Cooperating with the foil stator 17 is an arch-shaped multi-blade cutter 18 whose rectangular case 19 is provided with a projecting pin 20 which is driven by a vibrator 16 reciprocate the cutter to shear the hairs protruding through the foil apertures.

A reciprocating dry shaver in accordance with the invention is driven by a dc motor M which is either powered by a battery housed in the case of the shaver, or powered through a line by an external source.

The rotary motion of motor M is converted into reciprocating motion to drive the three assemblies 14, 15 and 16 by means of respective vibrators 21, 22 and 23. These are coupled to the drive pin 20 of the cutter blade 18 of the assembly.

To actuate vibrations 21, 22 and 23, the rotating shaft of motor M is coupled to a gear train G which acts to concurrently rotate a trio of axles 24, 25 supported in bearings and 26 operatively coupled to the respective vibrators 21, 22 and 23.

In operation, motor M acts through gear train G to rotate axles 24, 25 and 26 which drive vibrators 21, 22 and 23 to cause the blades of the assembly to reciprocate at a rapid rate to effect a fast shearing operation.

While there has been disclosed and illustrated a preferred embodiment of the invention, it is to be understood that many changes may be made therein without departing from the essential spirit of the invention.

Thus instead of a shaver assembly as shown in FIG. 5, in which the multi-blade cutter is arch-shaped, the cutter may have a somewhat flat top, in which event the metal foil stator will also be flat rather than arcuate in shape.

It is to be appreciated that whilst the illustrated embodiment shows a trio of shaver assemblies arranged in a triangle configuration, the number of shaver assemblies may be greater and they may be arranged in different configurations.

1. A rapid action reciprocating shaver provided with a shaving head adapted to sweep over a broad facial skin path to sheer the hairs encompassed by this path, said head comprising:
A plurality of like linear reciprocating assemblies, each assembly having a rectangular face that makes contact with a corresponding area of the skin whereby the aggregate skin area engaged by the trio is relatively large and all hairs thereon are intercepted by the head regardless of the direction of the sweep.

2. A shaver according to claim 1, wherein there is provided a trio of like linear reciprocating assemblies forming the legs of a triangle.

2. A shaver as in claim 2, in which the triangle is an equilateral triangle.

3. A dry shaver as set forth in claim 1, in which each assembly in the trio is caused to reciprocate at a rapid rate by a vibrator.

4. A shaver as set forth in claim 3, in which the vibrator is driven by a rotating motor.

5. A shaver as in claim 1 in which the face of each assembly is formed by an apertured metal foil which combs the skin to cause its hairs to protrude through the apertures, and a multi-blade cutter associated with the foil that is reciprocating to shear the protruding hairs.

6. A shaver as in claim 5, in which the foil is made of a thin sheet of stainless steel.

7. A shaver as in claim 5, in which the cutter has an arch shape.

8. A shaver as in claim 5, in which the cutter in each assembly is supported by a case having a drive pin coupled to a vibrator actuated by a rotating motor.

9. A shaver as in claim 8, in which the drive pins of the cutters in the reciprocating assemblies are linked to respective vibrators which are separately actuated through a gear train from a common motor.

10. A shaver as in claim 9, in which the motor is a DC motor which is battery powered.

11. A shaver according to claim 1, wherein there are provided four linear reciprocating shaver assemblies, each disposed along a square.
